(19) United States
(12) Patent Application Publication
(10) Pub. No.: US 2026/0191353 A1
(43) Pub. Date: Jul. 9, 2026

(54) EXTRACTION SYSTEMS AND METHODS FOR USING SAME

(71) Applicant: Vita-Mix Management Corporation, Olmsted Township, OH (US)

(72) Inventors: Thomas Clynne, Lakewood, OH (US); Mark J. Mayer, Sagamore Hills, OH (US); John Edward Chancey, IV, Olmsted Falls, OH (US); Gary Utterback, Novelty, OH (US); Jonathan Robert Meyer, Shaker Heights, OH (US)

(73) Assignee: Vita-Mix Management Corporation, Olmsted Township, OH (US)

(21) Appl. No.: 19/443,461

(22) Filed: Jan. 8, 2026

Related U.S. Application Data
(60) Provisional application No. 63/743,016, filed on Jan. 8, 2025.

(51) Int. Cl. A47J 31/52; A23F 5/26; A47J 31/06; A47J 31/46; A47J 31/58

(52) U.S. Cl. CPC A47J 31/5251; A23F 5/26; A47J 31/0657; A47J 31/467; A47J 31/58

(57) ABSTRACT

A system for extracting dissolvable material from a solute is disclosed herein. The system includes a container removably holding a solute and a solvent, a pressure regulator controlling a pressure within the container, and a controller communicatively coupled to the pressure regulator and configured to send pressure cycling instructions to the pressure regulator to enact at least one pressure cycle within the container. Each pressure cycle includes a pressurization period to a target pressure level and a depressurization period from the target pressure level to a resting pressure level less than the target pressure level. Also disclosed herein is a controller for extracting dissolvable material from a solute removably held within a container and a method for extracting dissolvable material from a solute.

### CROSS-REFERENCE TO RELATED APPLICATION

This application claims priority from U.S. Provisional Application No. 63/743,016, filed Jan. 8, 2025, for “Extraction Systems and Method for Using Same,” which is hereby incorporated by reference in its entirety including the drawings.

### TECHNICAL FIELD

The present specification generally relates to systems and methods for extracting soluble fractions of dissolvable materials into a liquid solvent and, more specifically, cold brew systems for rapid extraction of coffee into water.

### BACKGROUND

The current state of the art includes numerous and varying methods for extracting dissolvable solids from ground coffee. One common method for extracting dissolvable solids from ground coffee is to immerse ground coffee into hot water near boiling temperature and allow it to steep for a period of time. Another common method includes pouring the hot water over the ground coffee and allowing the hot water to extract the dissolvable solids from the ground coffee.

While these methods are suitable for extracting the solids, dissolving the solids from ground coffee into near boiling water will extract a wide variety of solids and chemicals from the ground coffee, which can tend to make the resulting liquid brewed coffee taste bitter and/or sour. As a method of combating the extraction of these bitter and/or sour chemicals, a method described as “cold brewing” has been developed whereby the ground coffee is immersed in water, which is not considered “hot”, and is allowed to soak for an extended period of time, usually hours. The chemicals associated with the negative bitter and/or sour taste profile of coffee are generally more soluble at higher temperatures versus the amount of those chemicals that might be extracted using cooler water. The chemicals associated with a more pleasant flavor experience are generally soluble at cooler temperatures. Thus, by using cooler water, a beverage can be created that exhibits a more rich flavor, higher caffeine content, and other desirable flavor notes while avoiding the above negative aspects of the flavor experience provided by the chemicals extracted from hotter water.

Accordingly, a need exists for the rapid extraction and dissolution of solid materials into liquids. As a specific example, there is a need to be able to rapidly extract the dissolvable solids from ground coffee into water or other liquids.

### SUMMARY

In one embodiment, a system for extracting dissolvable material from a solute is disclosed. The system includes: a container removably holding a solute and a solvent for extracting dissolvable material from the solute into the solvent; a pressure regulator controlling a pressure within the container; and a controller communicatively coupled to the pressure regulator and configured to send pressure cycling instructions to the pressure regulator to enact at least one pressure cycle within the container, each pressure cycle including a pressurization period to a target pressure level and a depressurization period from the target pressure level to a resting pressure level less than the target pressure level, the pressure cycling instructions including at least one of a target number of pressure cycles, a pressurization time corresponding to a duration of the pressurization period, a target pressure level dwell time for which the pressure in the container is maintained at the target pressure level, a depressurization time corresponding to a duration of the depressurization period, and a resting pressure level dwell time for which the pressure in the container is maintained at the resting pressure level.

In another embodiment, a controller for extracting dissolvable material from a solute removably held within a container is disclosed. The container removably holds a solvent for extracting the dissolvable material from the solute into the solvent. The controller is configured to: send pressure cycling instructions to a pressure regulator to enact at least one pressure cycle within the container, each pressure cycle including a pressurization period to a target pressure level and a depressurization period from the target pressure level to a resting pressure level less than the target pressure level, the pressure cycling instructions including at least one of a target number of pressure cycles, a pressurization time corresponding to a duration of the pressurization period, a target pressure level dwell time for which the pressure in the container is maintained at the target pressure level, a depressurization time corresponding to a duration of the depressurization period, and a resting pressure level dwell time for which the pressure in the container is maintained at the resting pressure level.

In yet another embodiment, a method for extracting dissolvable material from a solute is disclosed. The method includes: inserting a solute and a solvent into a container; operating a user interface to select one or more characteristics of a solution that is produced by extraction of a dissolvable material of the solute into the solvent; transmitting a signal containing the selected one or more characteristics from the user interface to a controller; determining, via the controller, pressure cycling instructions for achieving the one or more selected characteristics, the pressure cycling instructions including at least one of a target number of pressure cycles, a pressurization time corresponding to a duration of a pressurization period during which pressure in the container increases to a target pressure level, a target pressure level dwell time for which pressure in the container is maintained at the target pressure level, a depressurization time corresponding to a duration of a depressurization period during which the pressure in the container decreases from the target pressure level to a resting pressure level less than the target pressure level, and a resting pressure level dwell time for which the pressure in the container is maintained at the resting pressure level; and transmitting the pressure cycling instructions to a pressure regulator to enact at least one pressure cycle within the container, the pressure cycle at least partially assisting in the extraction of the dissolvable material of the solute into the solvent to produce the solution having the one or more selected characteristics, each pressure cycle including the pressurization period to the target pressure level and the depressurization period from the target pressure level to the resting pressure level.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts individual components of an extraction system, according to one or more embodiments shown and described herein;

FIG. 2 schematically depicts a front view of an embodiment of an extraction system, according to one or more embodiments shown and described herein;

FIG. 3 schematically depicts a front view of another embodiment of an extraction system, according to one or more embodiments shown and described herein; and

FIG. 4 depicts a flowchart illustrating a method for extracting dissolvable materials into a solvent, according to one or more embodiments shown and described herein.

### DETAILED DESCRIPTION

Embodiments described herein are directed to an extraction system including a container, a pressure regulator, and a controller communicatively coupled to the pressure regulator. The controller sends pressure cycling instructions to the pressure regulator to enact at least one pressure cycle within the container, where each pressure cycle includes a pressurization period to a target pressure level and a depressurization period to a resting pressure level less than the target pressure level. In embodiments, the extraction system may also include a temperature regulator communicatively coupled to the controller. In such embodiments, the controller also sends temperature instructions to the temperature regulator to achieve a target temperature of a solvent within the container. Controlling at least one of the pressure within the container and the temperature of the solvent in the container increases an extraction efficiency of a solute provided in the container with the solvent.

Various embodiments of the extraction system and the operation of the extraction systems are described in more detail herein. Whenever possible, the same reference numerals will be used throughout the drawings to refer to the same or like parts.

Ranges can be expressed herein as from one or “about” one particular value, and/or to or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein-for example front-are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

Cold brew coffee systems have become increasingly popular due to their ability to produce a smooth, low-acidity coffee concentrate. Traditional cold brew methods involve steeping coarse coffee grounds in cold or room-temperature water for an extended period, typically ranging from 12 to 24 hours. This prolonged brewing time allows for the gradual extraction of flavors and aromatic compounds while minimizing the release of acidic and bitter elements, resulting in a mellow and rich coffee profile. Despite these advantages, the slow extraction process is often inconvenient for consumers and commercial establishments, where efficiency and time savings are critical.

Existing cold brew systems are largely passive, relying on time rather than active mechanisms to achieve the desired extraction. This limitation poses several drawbacks. The lengthy steeping period reduces throughput for businesses, delays consumption for home users, and increases the risk of contamination if proper storage conditions are not maintained. Efforts to expedite the process through agitation or fine grinding often lead to inconsistent extraction or undesirable over-extraction, resulting in bitter flavors. Additionally, many systems lack flexibility to adjust brewing conditions, such as pressure or temperature, which could optimize extraction efficiency. These shortcomings highlight a need for innovative solutions that address the time-intensive nature of cold brewing while preserving the high-quality characteristics of the resulting coffee.

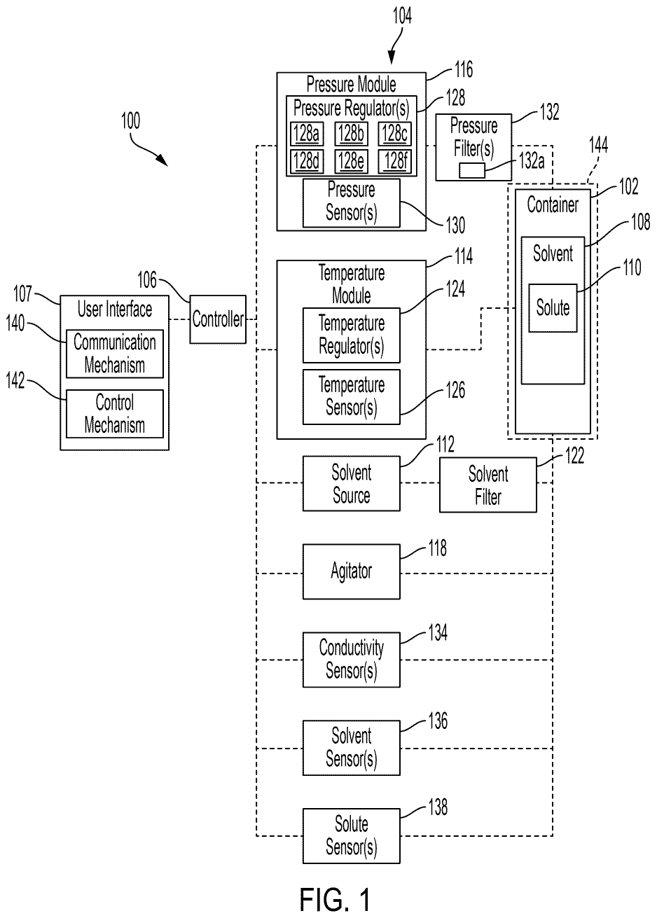

Referring now to FIG. 1, a system 100 for extracting dissolvable material from a solute (i.e., an extraction system 100) is depicted generally including a container 102 (e.g., a selectively closable container 102), a plurality of extraction components 104, a controller 106 communicatively coupled to at least a portion of the extraction components 104, and a user interface 107 communicatively coupled to the controller 106.

The container 102 removably holds a solvent 108 (e.g., water) and a solute 110 (e.g., coffee grounds). Thus, the solvent 108 infiltrates the solute 110 to extract dissolvable material from the solute 110 within the container 102. In embodiments in which the solute 110 is or includes coffee grounds and the solvent 108 is or includes water, the solution produced via the extraction of the dissolvable material of the coffee grounds into the water is coffee (e.g., cold brew coffee). Although the solute 110 is described herein as being or including coffee grounds, the solute 110 may include any other desired product such as, but not limited to, tea leaves, herbs, roots, grains, spices, powdered milk, cocoa grounds, protein powders, powdered drink mixes, fruits, vegetables, and any other product having dissolvable materials and/or extractable flavors. Further, in embodiments, the solute 110 may include more than one product, for example, coffee grounds and dried blueberries.

In embodiments or as desired, the solute 110 is suspended directly within the solvent 108 in the container 102. In other embodiments or as desired, the solute 110 may be positioned in a separate vessel within the container 102. In such embodiments, the vessel may permit the solvent 108 to flow into the vessel where the solvent 108 infiltrates the solute 110 and extracts the dissolvable material from the solute 110. The vessel may also permit the solvent 108 to flow out from the vessel while carrying at least a portion of the extracted dissolvable material. In examples, the vessel may comprise a mesh material (e.g., metal mesh filter), a porous material (e.g., paper filter, tea bag, etc.), or other suitable vessel.

The extraction system 100 may include any number of extraction components 104 for causing the desired extraction, increasing the efficiency of the desired extraction, and/or monitoring the desired extraction. For example, as shown in the embodiment of FIG. 1, the extraction components 104 may include a solvent source 112, a temperature module 114, a pressure module 116, an agitator 118, one or more sensors for formulating and/or monitoring the extraction process, one or more filters, and/or one or more sensors for measuring selected properties of the solvent 108, the solute 110, and/or the solution.

The solvent source 112, when provided, may be fluidly coupled to the container 102. Via the solvent source 112, the container may be filled and readily replenished with solvent 108 so as to achieve and maintain a predetermined threshold of solvent 108 in the container 102. In embodiments, the solvent source 112 may be a refillable or non-refillable tank of solvent 108. In other embodiments, the solvent source 112 may be a solvent supply line (e.g., a water supply line) that delivers solvent 108 to the container 102 from a central source when prompted.

Regardless of the form of the solvent source 112, a solvent filter 122 may be provided fluidly between the solvent source 112 and an interior of the container 102 so as to filter out unwanted substances/chemicals and/or impurities from the solvent 108. Such solvent filtration may help produce a consistent extraction performance, prevent contamination, and/or provide for a desired taste profile. In embodiments, the solvent filter 122 may include one or more reverse osmosis filters, activated carbon filters, sediment filters, UV filters, ceramic filters, ion exchange filters, and/or the like.

The temperature module 114, when provided, includes at least one temperature regulator 124 operatively connected to the container so as to selectively control a temperature of the solvent 108 within the container 102. It should be noted that the rate of extraction of certain dissolvable materials of the solute 110 (e.g., caffeine from coffee grounds) is a function of the temperature of the solvent 108. Specifically, the rate of extraction increases as the temperature of solvent increases. By altering the temperature of the solvent 108 within the container 102, the extraction time to extract the desired amount of dissolvable material from the solute 110 may be reduced or increased. Accordingly, the solvent 108 can be brought to a target temperature to at least partially assist in the extraction of the dissolvable material.

Each temperature regulator 124 may be provided adjacent to, on, or in the container 102 in order to regulate (e.g., raise, lower, or maintain) the temperature of the contained solvent 108. Each temperature regulator 124 may be or include one or more components provided for such temperature regulation functionality. For example, each temperature regulator 124 may be or include one or more electric resistance coils, ceramic heating elements, positive temperature coefficient heating elements, immersion heaters, induction heating coils, Peltier junction devices, and/or the like.

The temperature module 114 may also include at least one temperature sensor 126 adjacent to, on, or in the container 102 for measuring the temperature of the solvent 108 within the container 102. Each temperature sensor 126 may be or include, for example, one or more thermistors, thermocouples, resistance temperature detectors, integrated circuit sensors, silicone diode sensors, infrared thermometers, optical pyrometers, bimetallic thermometers, and/or the like.

The pressure module 116, when provided, includes at least one pressure regulator 128 operatively connected to the container 102 so as to selectively control a pressure within the container 102. By altering the pressure within the container 102, the extraction time to extract the desired amount of dissolvable material from the solute 110 may be reduced. Each pressure regulator 128 thus may be provided adjacent to, on, or in the container 102 in order to regulate (e.g., raise, lower, or maintain) the pressure in the container 102. Each pressure regulator 128 may be or include one or more components provided for such pressure regulation functionality. For example, each pressure regulator 128 may be or include one or more pumps 128a, 128b, 128c for increasing and maintaining the pressure within the container 102, one or more pressure relief valves 128d for decreasing and maintaining the pressure within the container 102, one or more compression mechanisms 128e that selectively compress the container 102 to increase and maintain the pressure within the container 102, one or more inflatable mechanisms 128f that are selectively inflated to increase and maintain the pressure within the container 102, and/or the like.

The one or more pumps may be, for example, any suitable fluidic (e.g., pneumatic or liquid) pump 128a, a hydraulic pump 128b, and/or a mechanical pump 128c. A fluidic pump 128a, when provided, may be operable to deliver at least one pressurizing fluid (e.g., one or more gasses and/or one or more liquids) to the container 102 and/or to a pressure chamber 144 in which the container 102 is received to increase and maintain the pressure within the container 102. In embodiments, the fluidic pump 128a may include a pneumatic fluidic pump 128a that includes a compressor for generating air/gas as a pressurizing fluid. In other embodiments, the fluidic pump 128a may include a liquid fluid pump 128a that is operatively connected to a liquid pressurizing fluid source and operable to deliver the liquid pressurizing fluid to the container 102 and/or the pressure chamber 144. As one example, the liquid fluidic pump 128a may be operatively connected to the solvent source 112 such that operation of the liquid fluidic pump 128a may cause additional solvent 108 to be delivered to the container 102 to increase the pressure within the container 102.

Each pressure relief valve 128d, when provided, may be selectively opened from a closed condition to vent the interior of the container 102 atmosphere and cause a decrease in pressure. Each pressure relief valve 128d may be manually and/or electrically controlled. Examples of manually controlled pressure relief valves 128d include ball valves, gate valves, globe valves, needle valves, butterfly valves, and the like. Examples of electrically controlled pressure relief valves 128d include solenoid valves, electric actuated ball valves, electric actuated butterfly valves, modulating control valves, and the like.

Each compression mechanism 128e, when provided, may be selectively connected to the container 102 and selectively operated to cause the compression mechanism 128e to compress the container 102, thereby increasing/maintaining the pressure within the container 102. In embodiments that include the compression mechanism(s) 128e, at least a portion of the container 102 may be elastically deformable, though all or a substantially portion of the container 102 may be rigid if desired. Examples of compression mechanisms 128e include manually, semi-automatic, or automatic vices, clamps, and the like. It should be noted that the motion/operation of the compression mechanism(s) 128e may be reversed after compressing the container 102, thereby responsively causing a decrease in pressure in the container 102.

Each inflatable mechanism 128f, when provided, may be selectively provided in the container 102 and is selectively inflatable via pressurizing fluids provided via one or more pump-based pressure regulators 128a, 128b, 128c. Inflation of the one or more inflatable mechanisms 128f responsively causes an increase in pressure in the container 102. It should be noted that the one or more inflatable mechanisms 128f may be selectively deflated after being inflated, which thereby responsively causes a decrease in pressure in the container 102.

The pressure chamber 144, when provided, receives (e.g., removably receives) the container 102 containing the solvent and the solute. In embodiments that include the pressure chamber 144, at least a portion of the container 102 may be deformable (e.g., elastically deformable) or the container 102 may be rigid. One or more pressure regulators 128 may be operatively connected to the pressure chamber 144 to control the pressure within both the pressure chamber 144 and the container 102 received within the pressure chamber 144. For example, one or more pumps 128a, 128b, 128c, one or more pressure relief valves 128d, and/or one or more inflatable members 128f may be provided on, in, and/or adjacent to the pressure chamber 144 so as to control the pressure within the pressure chamber 144. Therefore, even though the one or more pressure regulators 128 are not directly connected to the container 102 located in the pressure chamber 144, the one or more pressure regulators 128 are still operatively connected to the container 102 so as to control the pressure within the container 102.

The pressure module 116 may also include at least one pressure sensor 130 adjacent to, on, or in the container 102 for measuring a level of the pressure within the container 102. Each pressure sensor 130 may be or include, for example, one or more piezoresistive pressure sensors, capacitive pressure sensors, piezoelectric pressure sensors, Bourdon tube pressure sensors, manometers, vibrating element pressure sensors, and/or the like.

In embodiments that include a pressure regulator 128 in the form a fluidic pump 128a, at least one pressure filter 132 may be provided between the fluidic pump pressure regulator 128a and an interior portion of the container 102 that holds the solvent 108 and the solute 110. The pressure filter 132 thus is provided to filter out unwanted substances/chemicals and/or impurities from the pressurizing fluids (e.g., gas and/or liquid) used by the fluidic pump pressure regulator 128a. The pressure filter 132 may also or instead be provided to remove moisture from gas/air generated via a pneumatic fluidic pressure regulator 128. Such pressurizing fluid filtration/drying may help produce a consistent extraction performance, prevent contamination, and/or provide for a desired taste profile. In embodiments, the pressure filter 132 may include one or more high-efficiency particulate air (HEPA) filters, ultra-low penetration air (ULPA) filters, activated carbon filters, bag filters, reverse osmosis filters, sediment filters, ultraviolet filters, ion exchange filters, elastically deformable membranes 132a positionable to cover an opening of the container 102, refrigerated dryers, desiccant dryers, membrane dryers, and/or the like. It should be noted that in embodiments in which the container 102 is received within the pressure chamber 144, an elastically deformable membrane 132a may be provided to cover an opening of the container 102 and prevent the pressurizing fluid from contaminating and/or contacting the solvent 108, the solute 110, and/or the solution within the container 102.

The agitator 118, when provided, is operatively connected to the container 102 so as to selectively agitate the solvent 108, the solute 110, and the solution within the container 102. For example, the agitator 118 may stir, mix, and/or suspend the solute 110 in the solvent 108 and/or the solution to assist in extracting the dissolvable material from the solute 110, provide for a more uniform solution, prevent the solute 110 from settling at an interior bottom surface of the container 102, and/or for providing a consistent solution quality. The agitator 118 may thus be provided adjacent to, on, or in the container in order to agitate the contents of the container 102. The agitator 118 may include one or more mechanical agitators (e.g., impellers/propellers, shakers/orbital mixers, or homogenizers), magnetic agitators (e.g., magnetic stirrers), sonic agitators (e.g., ultrasonic transducers), and/or the like.

The conductivity sensor(s) 134, when provided, may be operatively connected to the container 102 so as to measure an electrical conductivity of the solvent 108 and/or solution. Therefore, the conductivity sensor 134 may be adjacent to, on, or in the container 102 to obtain such electrical conductivity measurements. The conductivity sensor 134 may be or include, for example, one or more contacting sensors (e.g., 2- or 4-electrode contacting sensors), inductive (toroidal) sensors, ultrasonic sensors, and/or the like.

It should be noted that the amount of extracted dissolvable material at any given point during or after the extraction process can be measured by measuring the electrical conductivity of the solvent 108 and/or produced solution. This is because ionic concentrations of the extracted dissolvable material increases as the dissolvable material of the solute 110 dissolves into the solvent 108. An increase in these ionic concentrations causes a commensurate increase in electrical conductivity. Accordingly, the amount of dissolvable material (e.g., chemicals) being extracted from the solute at any point can be inferred by or directly determined by measuring the electrical conductivity of the solvent 108 and/or the solution. As an example, the amount of caffeine (a dissolvable material of the solute 110) being extracted from the solute 110 at any given temperature can be correlated to the electrical conductivity of the solvent 108 and/or the solution at that temperature.

The extraction system 100 may include one or more solvent sensors 136 for measuring one or more selected properties of the solvent 108 as certain properties may affect the consistency of the extraction, the efficiency of the extraction, and/or the taste profile of the produced solution. This measurement may occur before the solvent 108 mixes with the solute 110 in the container 102. Each solvent sensor 136 may be operatively connected to the solvent source 112, fluidly interposed between the solvent source 112 and the container 102, and/or operatively connected to the container 102. When operatively connected to the container 102, the solvent sensor 136 may be adjacent to, on, or in the container 102 in order to measure the selected properties of the solvent 108. At least one solvent sensor 136 of the extraction system 100 may also be configured to determine a volume of the solvent 108 in the container 102.

The selected properties measured by each solvent sensor 136 may include, but are not limited to, hardness, pH, chlorine, alkalinity, any other selected property of the solvent 108, or any combination thereof. When measuring for hardness, the solvent sensor 136 may include one or more ion-selective electrode sensors (e.g., calcium or magnesium ion sensors), colorimetric/spectrophotometric analyzers, fiber optic sensors, electrical conductivity sensors, and/or the like. When measuring for pH, the solvent sensor 136 may detect the concentration of hydrogen ions in the solvent 108 using, e.g., a glass electrode and a reference electrode. When measuring for chlorine, the solvent sensor 136 may include one or more amperometric sensors (e.g., open amperometric sensors, membrane-covered amperometric sensors, or potentiostatic amperometric sensors). When measuring for alkalinity, the solvent sensor 136 may utilize methods such as, but not limited to, automated titration, spectrophotometry, or ion-selective electrodes to measure carbonate, bicarbonate, and/or hydroxide levels of the solvent 108.

The extraction system 100 may include one or more solute sensors 138 for measuring one or more selected properties of the solute 110 as certain properties of the solute 110 may affect the consistency of the extraction, the efficiency of the extraction, and/or the taste profile of the produced solution. This measurement may occur before the solute 110 mixes with the solvent 108 in the container 102. Each solute sensor 138 may be operatively connected to the container 102, to the source of the solute 110, or otherwise located as to measure the selected properties of the solute 110. Example selected properties of the solute 110 may include, but are not limited to, one or more of a brand of the solute, a roast level, freshness, grind size, predetermined desired ratio of solvent to solute, and the like. While the solute sensor 138 may employ specific sensors for measuring at least one of the noted selected properties of the solute 110, the solute 110 may come prepackaged having a readable code (e.g., a barcode or QR code) or tag (near-field communication tag or radio-frequency identification tag) representing or storing data that corresponds to the one or more selected properties of the solute 110. The data may be identified by the solute sensor 138 via an optical scanner or antenna of the solute sensor 138.

The user interface 107 may include a user communication mechanism 140 (e.g., a display screen, lights, and/or a speaker) and a user control mechanism 142 via which the user may input information regarding the extraction process, the solute 110, the solvent 108, and/or the desired solution. The user control mechanism 142 may include one or more switches, toggles, mechanical buttons, capacitive buttons, microphones, any other mechanism via which the user can input information, or any combination thereof. In embodiments, the user control mechanism 142 provides a user with the ability to select one or more characteristics of the solution produced by the extraction of the dissolvable material of the solute 110 into the solvent 108. The selectable characteristics of the solution may include, but are not limited to, temperature, caffeine content, bitterness, acidity, sweetness, mouthfeel, flavor characteristic(s), and the like. In embodiments, the user control mechanism 142 may also provide a user with the ability to select one or more operating characteristics provided by certain ones of the extraction components 104, so as to provide the user with the ability to finely tune the extraction system 100 and the extraction process in a desired manner. As an example, a user may operate the user control mechanism 142 to select the temperature of the solvent 108, as controlled by the temperature regulator(s) 124. As another example, a user may operate the user control mechanism 142 to select a range of temperatures between which the solvent 108 will be heated and cooled, as controlled by the temperature regulator(s) 124. As another example, a user may operate the user control mechanism 142 to select the pressure at which the container 102 will be pressurized to, as controlled by the pressure regulator(s) 128 (e.g., the pump and/or the pressure relief valve). As another example, a user may operate the user control mechanism 142 to select a range of pressures between which the container 102 will be pressurized and depressurized, as controlled by the pressure regulator(s) 128 (e.g., the pump and the pressure relief valve). As another example, a user may operate the user control mechanism 142 to select an amount of solvent 108 to add to the container 102, as controlled by the solvent source 112.

The controller 106 is communicatively coupled to the user interface 107 and one or more of the extraction components 104. For example, in addition to the user interface 107, the controller 106 may be communicatively coupled to one or more of the solvent source 112, the solvent filter 122, the temperature module 114 (e.g., to the temperature regulator(s) 124 and the temperature sensor(s) 126), the pressure module 116 (e.g., to the pressure regulator(s) 128 and pressure sensor(s) 130), the pressure filter(s) 132, the agitator 118, the conductivity sensor(s) 134, the solvent sensor(s) 136, and the solute sensor(s) 138. The controller 106 includes a processor and non-transitory electronic memory that stores a set of machine readable instructions. The processor executes the machine readable instructions stored in the non-transitory electronic memory. The processor may be any device capable of executing machine readable instructions. For example, the processor may be an integrated circuit, a microchip, a computer, or any other computing device. The non-transitory electronic memory may comprise RAM, ROM, flash memories, hard drives, or any device capable of storing machine readable instructions such that the machine readable instructions can be accessed by the processor. The machine readable instructions comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable instructions and stored in the non-transitory electronic memory. Alternatively, the machine readable instructions may be written in a hardware description language (HDL), such as logic implemented via either a field-programmable gate array (FPGA) configuration or an application-specific integrated circuit (ASIC), or their equivalents. The non-transitory electronic memory may be implemented as one memory module or a plurality of memory modules.

In embodiments, the controller 106 may receive signals from the user interface 107 corresponding to the user selected characteristics of the solution and/or the user selected operating characteristics. Utilizing at least the received interface signals, the controller 106 determines instructions for one or more of the extraction components 104 for achieving the selected characteristics of the solution and/or the selected operating characteristics. For example, based on the selected solution characteristics and/or operating characteristics, the controller 106 may instruct one or more of the temperature sensor(s) 126, the pressure sensor(s) 130, the conductivity sensor(s) 134, the solvent sensor(s) 136, and the solute sensor(s) 138 to obtain their respective measurements and/or to begin taken measurements continuously or periodically. Using these measurements and the user selected characteristics and/or the user selected operating characteristics, the controller 106 may determine and send instructions to one or more of the solvent source 112, the solvent filter 122, the temperature regulator(s) 124, the pressure regulator(s) 128, the pressure filter 132, and the agitator 118 to achieve a desired and efficient extraction of the solute 110 into the solvent 108.

As one example, the controller 106 may send instructions to the solvent source 112 to achieve a desired volume of solvent 108 in the container. Further, the controller 106 may send instructions to the solvent filter 122 to achieve a desired filtration of the solvent 108 as it is delivered into the container 102.

The controller 106 may send temperature instructions to the temperature regulator(s) 124 to achieve and maintain a target temperature of the solvent 108 and/or the produced solution within the container 102. Under certain conditions, the temperature instructions may instruct the temperature regulator(s) to cycle the temperature of the solvent 108 during the extraction process between a minimum temperature (e.g., about 20-23° C., near 0° C., or any other desired minimum temperature) and a maximum temperature (e.g., near 100° C. or any other desired maximum temperature). The temperature instructions may be established and updated based on at least the temperature measurements provided by the temperature sensor(s) 126, though the temperature instructions may be established/updated in view of any of the other signals (e.g., from the user interface 107) or measurements.

The controller 106 may send pressure instructions to the pressure regulator(s) 128 for establishing and/or altering the pressure within the container 102. In particular, the pressure instructions may include pressure cycling instructions for the pressure regulator(s) 128 to enact at least one pressure cycle within the container 102. Each pressure cycle includes a pressurization period to a target pressure level (e.g., via a pump-based pressure regulator 128) and a depressurization period from the target pressure level to a resting pressure level less than the target pressure level (e.g., via a pressure relief valve-based pressure regulator 128). It has been found that the level of infiltration of the solvent 108 increases as the pressure in the container 102 increases. The solvent 108 infiltrating the solute 110 at least partially causes the extraction of the dissolvable material of the solute 110. The longer the duration of the pressurization period (i.e., the pressurization time), the greater the infiltration. Further, the target pressure level may be maintained for a selected duration (i.e., the target pressure level dwell time) to extend the duration of the infiltration level of the solvent 108 at the target pressure level. Accordingly, by increasing the pressure to the target pressure level and at least temporarily maintaining the pressure at the target level, the rate at which the dissolvable material is extracted from the solute 110 and the amount of extracted dissolvable material can be increased, thereby resulting in a more efficient extraction.

The correlation of the target pressure level and target pressure level dwell time can be appreciated in the following non-limited example tests. For example, during a control extraction test to measure extraction efficiency at which the pressure within a container is 0 psi, the electrical conductivity of the solvent/extracted solute mixture is 1,500 microsiemens per centimeter (μS/cm). During a first extraction test at which the pressure within the container is cycled to 10 psi with a 30 second dwell time, the electrical conductivity of the solvent/extracted solute mixture is 1,740 μS/cm. During a second extraction test at which the pressure within the container is cycled to 20 psi with a 30 second dwell time, the electrical conductivity of the solvent/extracted solute mixture is 1,750 μS/cm. During a third extraction test at which the pressure within the container is cycled to 30 psi with a 30 second dwell time, the electrical conductivity of the solvent/extracted solute mixture is 1,935 μS/cm. During a fourth extraction test at which the pressure within the container is cycled to 40 psi with a 30 second dwell time, the electrical conductivity of the solvent/extracted solute mixture is 1,800 μS/cm. During a fifth extraction test at which the pressure within the container is cycled to 50 psi with a 30 second dwell time, the electrical conductivity of the solvent/extracted solute mixture is 2,800 μS/cm. Accordingly, in view of these non-limiting example test, it can be observed that an increase in electrical conductivity is exhibited with an increase in pressure. A similar relationship exists whereby increasing the number of pressure cycles can increase the extraction efficiency. Likewise, increasing the target pressure level dwell time during the pressure cycle can increase the extraction efficiency.

During the depressurization period, the reduction in pressure permits the portions of the solvent 108 that had infiltrated the solute 110 to flow away from the solute 110 with the extracted dissolvable material. This results in a more efficient extraction process as the dissolvable material carrying-solvent 108 is compelled to mix with portions of the solvent 108 that may not have infiltrated the solute 110. The amount of the dissolvable material carrying-solvent 108 that flows away from the solute 110 increases as the duration of the depreciation period (i.e., the depressurization time) increases. The resting pressure level may be maintained for a selected duration (i.e., the resting pressure level dwell time) to extend the duration for which the dissolvable material carrying-solvent 108 freely mixes with other portions of the solvent 108. It should be noted that the reduction in pressure from the target pressure level can result in the formation of small bubbles, which create a foamy or frothy result and may be desirable to create a different mouthfeel or flavor characteristic. Accordingly, each pressure cycle may at least partially assist in the extraction of the dissolvable material of the solute 110 into the solvent 108.

The pressurization instructions may thus include at least one of the target pressure level, the resting pressure level, a target number of pressure cycles, the pressurization time, the target pressure level dwell time, the depressurization time, and the resting pressure level dwell. In embodiments or in certain scenarios, the pressurization instructions may include each one of these data points. The target pressure may be 10 psi, 20 psi, 30 psi, 40 psi, 50 psi, 100 psi, greater than 100 psi, or any other selected pressure/appropriate level. The resting pressure level may be about 0 psi or any other selected/appropriate pressure level that is less than that of the target pressure level. The target number of pressure cycles may be in the range of 1-15 pressure cycles, greater than 15 pressure cycles, or any other selected/appropriate number of pressure cycles. The pressurization time, target pressure level dwell time, the depressurization dwell time, and the resting pressure level dwell time may each be in the range of 1-60 seconds, greater than 60 seconds, or any other selected/appropriate duration of time.

The pressure cycling instructions may be established and updated based on at least the temperature measurements provided by the temperature sensor(s) 126, though the pressure cycling instructions may be established/updated in view of any of the other signals (e.g., from the user interface 107) or measurements. The pressure cycling instructions may also be established and updated based on the measurements provided by the conductivity sensor(s) 134.

When a pressure filter 132 controllable via the controller 106 is provided, the controller 106 may send instructions to the pressure filter 132 to achieve a desired filtration/moisture removal of the pressurization fluid (gas and/or liquid) of a pump-based pressure regulator 128 when the pump-based pressure regulator 128 utilizes such pressurization fluid to pressurize the container 102.

The controller 106 may also send instructions to the agitator(s) 118 to cause the agitator(s) 118 to agitate the solvent 108, the solute 110, and the solution within the container 102.

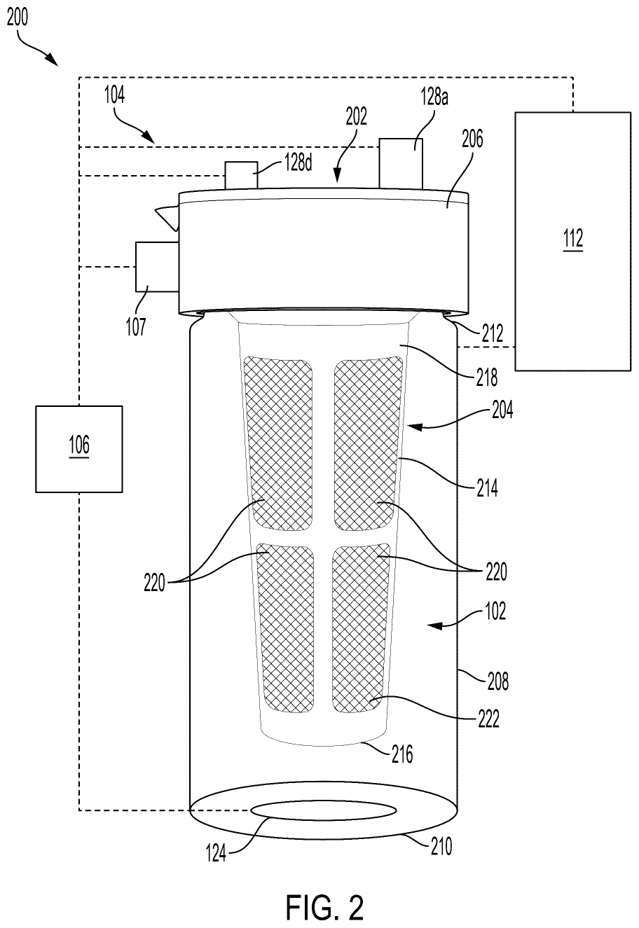

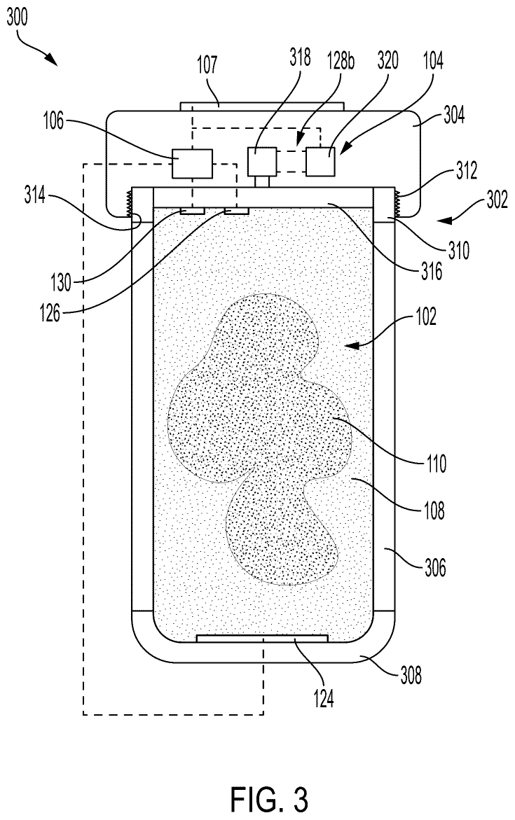

FIGS. 2-3 depict other embodiments of the extraction system 200, 300 having the same or like parts as the extraction system 100 of FIG. 1. Therefore, the functionality, operation, and/or alternatives of the same or like parts can be incorporated from the above for brevity. Furthermore, individuals components of each embodiment of the extraction system 100, 200, 300 may be incorporated into each of the other embodiments whether expressly stated or not.

Therefore, like the extraction system 100 of FIG. 1, the extraction system 200 of FIG. 2 generally includes a container 102, a plurality of extraction components 104, a controller 106 communicatively coupled to at least a portion of the extraction components 104, and a user interface 107 communicatively coupled to the controller 106.

The container 102 is a portion of a container assembly 202 that also includes a vessel 204 positionable within the container 102, and a lid 206 securable to the vessel 204 and the container 102 to maintain the position of the vessel 204 within the container 102. The container 102 includes one or more side walls 208, a bottom wall 210, and a top end 212 opposite the bottom wall 210. As shown in FIG. 2, the one or more side walls 208 form a single side wall having a cylindrical shape extending between the bottom wall 210 and the top end 212, though the container 102 and/or the one or more side walls 208 thereof may have any other desired shape. In embodiments, the top end 212 may include attachment mechanisms (e.g., threads) for engaging corresponding attachment mechanisms (e.g., threads) of the lid 206. In embodiments, the container 102 may be formed of stainless steel, glass, plastic, ceramic, aluminum, and/or the like.

The vessel 204 includes one or more side walls 214, a bottom wall 216, and a top end 218 including attachment mechanisms (e.g., threads) for engaging corresponding attachment mechanisms (e.g., threads) of the lid 206. The one or more side walls 214 includes one or more openings 220. The vessel 204 further includes a filter 222 positioned to cover each of the one or more openings 220. As shown in FIG. 2, the one or more side walls 214 form a single side wall having a conical wall tapering from the top end 218 to the bottom wall 216, and a plurality of openings 220 formed within the side wall 214 with each opening 220 covered by the filter 222. In embodiments, the side walls 214 and the bottom wall 216 of the vessel 204 may be formed of stainless steel, plastic, ceramic, aluminum, or the like. In embodiments, the filter 222 may be formed from stainless steel mesh, nylon mesh, silicone, and/or the like.

It should be appreciated that a reduction in the distance and volume of the solute 110 (FIG. 1) required for the solvent 108 (FIG. 1) to fully infiltrate the solute 110 may provide enhanced extraction. For example, placing the solute 110 in a vessel 204 that has a cylindrical shape may only expose an outer portion of the solute 110 and create a longer distance for complete infiltration as compared to a vessel 204 having a tubular shape in which both the inside and outside surfaces of the solute 110 are exposed to the solvent 108. Accordingly, the efficiency of the extraction may be increased or otherwise adjusted via the selection of the geometry of the vessel 204.

Although not shown, the pair of attachment mechanisms (e.g., threads) of the lid 206 are spaced apart from one another and are for separately engaging with the attachment mechanisms (e.g., threads) of the container 102 and the attachment mechanisms (e.g., threads) of the vessel 204. Accordingly, the vessel 204 may be initially secured to the lid 206. Thereafter, the vessel 204 is positioned within the interior of the container 102 and the lid 206 is separately secured to the container 102. It should be appreciated that the container 102 may first be filled within the solvent 108 and the vessel 204 filled with the solute 110. Thus, inserting the vessel 204 into the container 102 permits the solvent 108 to enter the vessel 204 through the filter 222 where the solvent 108 mixes with and at least partially extracts the dissolvable material from the solute 110. Further via, the filter 222, the solvent 108 carrying the dissolved material of the solute 110 may then be filtered through the filter 222 as the mixed solvent 108 and dissolved material flows out from the vessel 204.

The extraction components 104 of the extraction system 200 may include, for example, a temperature regulator 124 provided on the bottom wall 210 of the container 102, though the temperature regulator 124 may be provided at any other suitable location such as, for example, on the one or more side walls 208 and either on an inside surface or an outside surface of the container 102.

A pressure regulator 128 in the form of a pressure relief valve is indicated at 128d in FIG. 2. As shown, the pressure relief valve-based pressure regulator 128d is provided on the lid 206. However, it should be appreciated that the pressure relief valve-based pressure regulator 128d may be provided at any suitable location. A pressure regulator 128 in the form a fluidic pump (e.g., a pneumatic pump) is indicated at 128a in FIG. 2. Similar to the pressure relief valve-based pressure regulator 128d, the fluidic pump-based pressure regulator 128a is provided on the lid 206. However, it should be appreciated that the fluidic pump-based pressure regulator 128a may be provided at any suitable location.

The extraction system 200 also includes a solvent source 112 that is fluidly coupled to the container 102. In the depicted configuration, the solvent source 112 is a refillable or non-refillable tank of solvent 108, though the solvent source 112 of the extraction system 200 may be in any other desired form.

It should be appreciated that the fluidic pump-based pressure regulator 128a may be adapted to be a liquid pump instead of a pneumatic pump if desired. In such case, the fluidic pump-based pressure regulator 128a be operatively connected to the solvent source 112 and/or any other desired source of liquid pressurizing fluid. It should also be appreciated that the fluidic pump-based pressure regulator 128a, in certain embodiments, may be operatively connected to an inflatable member 128f (FIG. 1) positioned within the container 102 so as to selectively inflate the inflatable member with gas and/or liquid pressurizing fluid.

Although not shown, the extraction system 200 of FIG. 2 may include any of the sensors, filters, and/or agitators described in regard to the extraction system 100 of FIG. 1.

Similar to that of the extraction system 100 of FIG. 1, the extraction system 200 of FIG. 2 includes a controller 106 that is communicatively coupled to a user interface 107 and to one or more of the extraction components 104 of the extraction system 200. For example, the controller 106 is communicatively coupled to each of the user interface 107, the temperature regulator 124, the pressure relief valve-based pressure regulator 128d, the fluidic pump-based pressure regulator 128a, and the solvent source 112. Via the user interface 107 and the controller 106, the extraction system 200 may extract dissolvable material from the solute 110 in the same or similar manner as described above.

The extraction system 300 depicted in FIG. 3 includes a container 102, a plurality of extraction components 104, a controller 106 communicatively coupled to at least a portion of the extraction components 104, and a user interface 107 communicatively coupled to the controller 106.

The container 102 is a portion of a container assembly 302 that also includes a lid 304 securable to the container 102. The container 102 includes one or more side walls 306, a bottom wall 308, and a top end 310 opposite the bottom wall 308. As shown in FIG. 3, the one or more side walls 306 form a single side wall having a cylindrical shape extending between the bottom wall 308 and the top end 310, though the container 102 and/or the one or more side walls 306 thereof may have any other desired shape. In embodiments, the top end 310 may include attachment mechanisms 312 (e.g., threads) for engaging corresponding attachment mechanisms 314 (e.g., threads) of the lid 304. In embodiments, at least the one or more side walls 306 of the container 102 may be formed of an elastically deformable material such as, but not limited to, silicone, thermoplastic elastomers, food grade rubbers, and/or the like. The top end 310 and the bottom wall 308 of the container 102 may each be formed of the same material as the one or more side walls 306, or from a more rigid material such as, e.g., stainless steel, glass, certain plastics, ceramic, aluminum, and/or the like. In other embodiments, at least one of the top end 310 and the bottom wall 308 may be formed of the elastically deformable material, while the one or more side walls 306 may be formed of a more rigid material.

The solute 110 is shown as being suspended directly in the solvent 108 in FIG. 3. However, in embodiments, the container assembly 302 may include a vessel the same as or similar to the vessel 204 of FIG. 2 for selectively holding the solute 110 therein.

The extraction components 104 of the extraction system 300 may include, for example, a temperature regulator 124 provided on the bottom wall 308 of the container 102, though the temperature regulator 124 may be provided at any other suitable location such as, for example, on the one or more side walls 306 and either on an inside surface or an outside surface of the container 102.

A pressure regulator 128 in the form of a hydraulic pump is indicated at 128b in FIG. 3. As shown, the hydraulic pump-based pressure regulator 128b is provided in/on the lid 304. However, it should be appreciated that the hydraulic pump-based pressure regulator 128b may be provided at any suitable location. The hydraulic pump-based pressure regulator 128b includes a piston 316 at least partially in and movable relative to the container 102 when the lid 304 is joined to the container 102. The hydraulic pump-based pressure regulator 128b also includes a hydraulic cylinder 318 in which a portion of the piston 316 is slidably mounted. The piston 316 is drivable relative to the container 102 and the hydraulic cylinder 318 via a hydraulic actuator 320, which may include a hydraulic pump and a reservoir for pressurizing fluid. In use, the hydraulic actuator 320 may be instructed to drive the piston 316 towards the bottom wall 308 of the container 102 so as to increase the pressure within the container 102. The elastically deformable one or more side walls 306 may at least partially elastically deform in response to the increased pressure. Such elastic deformation at least partially reduces the likelihood that the increase in pressure will damage the container 102. Reducing the pressure in the container via either a pressure relief valve (not shown) or via returning the piston 316 to an initial position responsively permits the innate elasticity of the one or more side walls 306 to return the one or more side walls 306 to an initial position.

It should be appreciated that the pressure regulator 128 of the extraction system 300 may be converted into a mechanical pump-based pressure regulator 128c (FIG. 1) via the operable connection of the piston 316 to a motor (e.g., an electric motor) and the removal of at least the hydraulic actuator 320. Such a mechanical pump-based pressure regulator 128c may function to manipulate the pressure within the container 102 in the same or similar manner as described above.

The extraction components 104 of the extraction system 300 also includes a pressure sensor 130 and a temperature sensor 126, though the extraction system 300 may include any of the other sensors, filters, and/or agitators described in regard to the extraction system 100 of FIG. 1.

Similar to that of the extraction systems 100, 200 of FIGS. 1-2, the extraction system 300 of FIG. 3 includes a controller 106 that is communicatively coupled to a user interface 107 and to one or more of the extraction components 104 of the extraction system 300. For example, the controller 106 is communicatively coupled to each of the user interface 107, the temperature regulator 124, the hydraulic pump-based pressure regulator 128b, the pressure sensor 130, and the temperature sensor 126. Via the user interface 107 and the controller 106, the extraction system 300 may extract dissolvable material from the solute 110 in the same or similar manner as described above.

It should be appreciated that instead of or in addition to including the hydraulic pump pressure regulator 128b, the extraction system 300, in embodiments, may include at least one compression mechanism pressure regulator 128e (FIG. 1) that is operable to compress at least the elastically deformable portions of the container 102 (e.g., the one or more side walls 306) to increase/decrease the pressure within the container 102 in the same or similar manner as described above.

It should be appreciated that either of the containers 102 of the extraction systems 200, 300 of FIGS. 2-3 may be inserted (e.g., removably inserted) into a pressure chamber 144 (FIG. 1) with or without their respective lid 206, 304. As described above, one or more pressure regulators 128 may be operatively connected to the pressure chamber 144 to control the pressure within both the pressure chamber 144 and the container 102 received within the pressure chamber 144. These one or more pressure regulators 128 of the pressure chamber 144 function in the place of the pressure regulator(s) 128/128a/128d/128b on the lid 206/304 of the container 102 when the lid 206/304 is removed from the container 102, though the one or more pressure regulators 128 of the pressure chamber 144 may function in combination with the pressure regulator(s) 128/128a/128d/128b on the lid 206/304 when the lid 206/304 is maintained on the container 102. When the container 102 is inserted into the pressure chamber 144 without its respective lid 206/304, an opening at the top end 212/310 of the container 102 may be covered by a pressure filter 132 in the form of an elastically deformable membrane 132a (FIG. 1). As described above, the elastically deformable membrane pressure filter 132a may at least partially prevent pressurizing fluid from contacting and/or contaminating the contents within the container 102 when the pressure regulator(s) 128 of the pressure chamber 144 is a fluidic pump 128a that provides the pressurizing fluid to the pressure chamber 144.

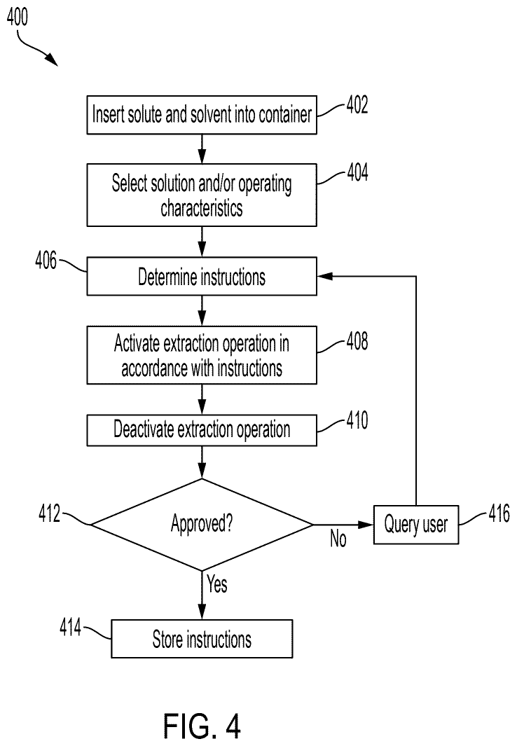

Referring now to FIG. 4, and with reference to the extraction systems 100, 200, 300 illustrated in FIGS. 1-3 (or otherwise described or constructed in view of the teachings herein), a flowchart depicting a method 400 for extracting dissolvable material from the solute 110 is illustrated. The method 400 includes inserting a solute 110 (e.g., coffee grounds) and a solvent 108 (e.g., water) into a container 102 at step 402. The ratio of solvent 108 to solute 110 may be in the range of 6:1 to 10:1. The solvent 108 may be delivered manually to the container 102 via the user or may be delivered to the container 102 via the solvent source 112. In embodiments, the solute 110 may be fully wetted prior to inserting the solute 110 into the container 102.

In embodiments, the solute 110 may be inserted directly into the solvent 108 in the container 102. In other embodiments, the insertion of the solute 110 and the solvent 108 into the container 102 includes inserting the solvent 108 into the container 102 and inserting the solute 110 into a vessel (e.g., the vessel 204 of FIG. 2) prior to inserting the solute 110 into the container 102. In embodiments, the solute 110 may be fully wetted prior to inserting the solute carrying vessel into the container 102. Additionally, in embodiments, a vacuum may be pulled on the solute 110 within the vessel prior to immersing the solute 110 in the solvent 108. Degassing the solute 110 allows the solvent 108 to infiltrate the solute 110 even at low pressures. The vessel carrying the solute 110 may then be inserted into the container 102 and secured in position within the container 102, for example, by engaging the vessel with a lid (e.g., the lid 206 of FIG. 2 or the lid 304 of FIG. 3) and further engaging the lid with the container 102, as described herein. In embodiments, the container 102 having the solute and solvent therein may be inserted into a pressure chamber 144 before proceeding with the remainder of the method 400.

At step 404, one or more characteristics of the solution (e.g., coffee or cold brew coffee) produced by the extraction of the dissolvable material of the solute 110 into the solvent 108 and/or one or more operating characteristics provided by certain ones of the extraction components 104 may be selected via the user interface 107. For example, via the user interface 107, a user may select certain characteristics for their desired solution (e.g., bitterness, sweetness, acidity, temperature, caffeine content, electrical conductivity of the solvent/extracted solute mixture in μS/cm, mouthfeel, flavor characteristic, and the like). Additionally or instead, the user may select one or more operating characteristics provided by certain ones of the extraction components 104, thereby permitting the user to finely tune the extraction system 100, 200, 300 and the extraction process in a desired manner. The selectable operating characteristics may include, but are not limited to, total duration of extraction process, the target temperature, the target pressure level, the resting pressure level, the target number of pressure cycles, the pressurization time, the target pressure level dwell time, the depressurization time, the resting pressure level dwell time, the target temperature, a degree of agitation, filtering characteristics, solvent volume, temperature cycling ranges, and the like.

At step 406, the controller 106 receives one or more signals transmitted by the user interface 107 that correspond to the user selected characteristics of the solution and/or the user selected operating characteristics, and then determines instructions for one or more of the extraction components 104 for achieving the selected characteristics of the solution and/or the selected operating characteristics. For example, based on the selected solution characteristics and/or operating characteristics, the controller 106 may instruct one or more of the temperature sensor(s) 126, the pressure sensor(s) 130, the conductivity sensor(s) 134, the solvent sensor(s) 136, and the solute sensor(s) 138 to obtain their respective measurements and/or to begin taken measurements periodically. Using these measurements and the user selected characteristics and/or the user selected operating characteristics, the controller 106 may determine instructions for one or more of the solvent source 112, the solvent filter 122, the temperature regulator(s) 124, the pressure regulator(s) 128, the pressure filter 132, and the agitator 118 to achieve a desired and efficient extraction of the solute 110 into the solvent 108.

Example instructions for individual extraction components 104 have been described above and, thus, each of the instructions will not be described again for brevity. However, as one example, the controller 106 may determine the pressure cycling instructions for achieving the selected characteristics of the solution and/or the selected operating characteristics based on the selected solution characteristics, the selected operating characteristics, and/or the sensor measurements. As described above, the pressure cycling instructions may include the target pressure level, the resting pressure level, the target number of pressure cycles, the pressurization time, the target pressure level dwell time, the depressurization time, and the resting pressure level dwell time. As another example, the controller 106 may determine the temperature instructions for achieving the selected characteristics of the solution and/or the selected operating characteristics based on the selected solution characteristics, the selected operating characteristics, and/or the sensor measurements. The temperature instructions may include at least the target temperature for the solvent 108 within the container.

At step 408, the controller 106 may activate the extraction operation by transmitting the determined instructions to one or more of the extraction components 104. Upon receipt, the extraction components 104 receiving the determined instructions operate in accordance with the received determined instructions. As one example, the pressure regulator(s) 128 may receive the determined pressure cycling instructions and enact the target number of pressure cycles within the container. As described above, each pressure cycle at least partially assists in the extraction of the dissolvable material of the solute 110 into the solvent 108 to produce a solution that has and/or is created in accordance with the selected characteristics. As noted above, depressurizing the container 102 to the resting pressure level can result in the formation of small bubbles, which create a foamy or frothy result and may be desirable to create a different mouthfeel or flavor characteristic. The formation of small bubbles in the solvent/solution as it depressurizes to the resting pressure level can be aided by the nozzle/aerator configuration of a fluidic pump 128a when the pressure regulator(s) 128 is or includes a fluidic pump 128a. The dissolution can also be performed using CO2 and may yield a “carbonated” result due to the higher solubility of CO2 into liquids.

As another example, the temperature regulator(s) 124 may receive the determined temperature instructions and achieve and maintain the target temperature for the solvent 108 in the container 102. As described above, achieving and maintaining the target temperature at least partially assists in the extraction of the dissolvable material of the solute 110 into the solvent 108 to produce a solution that has and/or is created in accordance with the selected characteristics.

During the activated extraction operation, the controller 106 may continue to receive all or certain sensor measurements. Via these sensor measurements, the controller 106 may update or determine new instructions in order to achieve the user's selected solution characteristics and/or selected operating characteristics. The sensor measurements may be transmitted to the controller 106 continuously or in periodic increments.

At step 410, the extraction operation is deactivated. This may occur upon completion of a selected or default total extraction process duration, upon achieving the target number of pressure cycles, upon achieving a desired electrical conductivity, upon achieving the user selected solution characteristics, upon achieving/completing the user selected operating characteristics, and/or as a result of any other selected or default condition. When the extraction operation is deactivated, the controller 106 instructs the extraction components 104 to stop operating. The solution produced via the extraction of the dissolvable material of the solute 110 into the solvent 108 may be dispensed from the container 102 following the deactivation of the extraction operation, though the user may instruct the controller 106 (e.g., via the user interface 107) to deactivate the extraction operation at any point during the extraction operation.

In embodiments, the method 400 ends with step 410. However, in other embodiments, the method 400 continues to step 412 where the user inputs into the user interface 107 whether they approve of the produced solution. If the user approves, the user interface 107 sends a signal to the controller 106 indicating such approval. At step 414, the controller 106 may then store any instructions used to produce the approved solution. Storing these instructions permits the user to instruct the controller 106 (via the user interface 107) to produce the same approved solution or a substantially similar version in the future.

If the user does not approve of the produced solution, the controller 106 instructs the user interface 107 to query the user, at step 416, for reasons for the disapproval. For example, the user interface 107 may ask the user if the temperature, bitterness, acidity, caffeine content, electrical conductivity, flavor characteristics, and/or the like of the produced solution need adjustment. The response(s) provided by the user may then be inputted into the user interface 107 and then transferred to the controller 106 so that the controller 106 may once again return to step 406 and continue with the method 400 in the manner described above, though the user may be instructed to refill or provide more of the solute 110 and/or the solvent 108 before returning to step 406. In embodiments, the user may provide their response to the query(ies), but instruct the controller 106 to not proceed with producing an updated solution. In such embodiments, the controller 106 may continue with step 406, but then store the updated instructions instead of proceeding to step 408. Storing these instructions permits the user to instruct the controller 106 (via the user interface 107) to produce the updated solution or a substantially similar version in the future.

Further aspects of the aspects described herein are provided by the subject matter of the following clauses:

A system for extracting dissolvable material from a solute, comprising: a container removably holding a solute and a solvent for extracting dissolvable material from the solute into the solvent; a pressure regulator controlling a pressure within the container; and a controller communicatively coupled to the pressure regulator and configured to: send pressure cycling instructions to the pressure regulator to enact at least one pressure cycle within the container, each pressure cycle including a pressurization period to a target pressure level and a depressurization period from the target pressure level to a resting pressure level less than the target pressure level, the pressure cycling instructions including at least one of a target number of pressure cycles, a pressurization time corresponding to a duration of the pressurization period, a target pressure level dwell time for which the pressure in the container is maintained at the target pressure level, a depressurization time corresponding to a duration of the depressurization period, and a resting pressure level dwell time for which the pressure in the container is maintained at the resting pressure level.

The system of any preceding clause, wherein the pressure cycling instructions include the target number of pressure cycles, the pressurization time, the target pressure level dwell time, the depressurization time, and the resting pressure level dwell time.

The system of any preceding clause, further comprising a pressure sensor for measuring a level of the pressure within the container, the pressure sensor being communicatively coupled to the controller, the controller configured to establish and update the pressure cycling instructions based on pressure level measurements provided by the pressure sensor.

The system of any preceding clause, wherein the pressure regulator comprises a pump operatively connected to the container, the pump selectively increasing the pressure within the container.

The system of any preceding clause, wherein the pump comprises a fluidic pump, a hydraulic pump, or a mechanical pump.

The system of any preceding clause, wherein the pressure regulator comprises a pressure relief valve operatively connected to the container, the pressure regulator selectively reducing the pressure within the container.

The system of any preceding clause, further comprising a user interface permitting a user to select one or more characteristics of a solution that is produced by the extraction of the dissolvable material of the solute into the solvent, the user interface communicatively coupled to the controller, the controller configured to establish and update the pressure cycling instructions based on the one or more selected characteristics provided by the user interface.

The system of any preceding clause, further comprising a temperature regulator communicatively coupled to the controller, the temperature regulator controlling a temperature of the solvent within the container, the controller configured to send temperature instructions to the temperature regulator to achieve a target temperature for the solvent within the container.

The system of any preceding clause, further comprising a temperature sensor for measuring the temperature of the solvent within the container, the temperature sensor communicatively coupled to the controller, the controller configured to establish and update the temperature instructions based on temperature measurements provided by the temperature sensor.

The system of any preceding clause, wherein the temperature regulator is provided on or in the container to regulate the temperature of the solvent contained within the container.

The system of any preceding clause, further comprising a user interface permitting a user to select one or more characteristics of a solution that is produced by the extraction of the dissolvable material of the solute into the solvent, the user interface communicatively coupled to the controller, the controller configured to establish and update the pressure cycling instructions and the temperature instructions based on the one or more selected characteristics provided by the user interface.

The system of any preceding clause, wherein: the solute comprises coffee grounds and the solvent comprises water; and the extraction of the dissolvable material of the coffee grounds into the solvent produces cold brew coffee.

A controller for extracting dissolvable material from a solute removably held within a container, the container removably holding a solute and a solvent for extracting dissolvable material from the solute into the solvent, the controller configured to: send pressure cycling instructions to a pressure regulator to enact at least one pressure cycle within the container, each pressure cycle including a pressurization period to a target pressure level and a depressurization period from the target pressure level to a resting pressure level less than the target pressure level, the pressure cycling instructions including at least one of a target number of pressure cycles, a pressurization time corresponding to a duration of the pressurization period, a target pressure level dwell time for which the pressure in the container is maintained at the target pressure level, a depressurization time corresponding to a duration of the depressurization period, and a resting pressure level dwell time for which the pressure in the container is maintained at the resting pressure level.

The controller of any preceding clause, wherein the controller is communicatively coupled to a user interface, the user interface permitting a user to select one or more characteristics of a solution that is produced by the extraction of the dissolvable material of the solute into the solvent, the controller configured to establish and update the pressure cycling instructions based on the one or more selected characteristics provided by the user interface.

The controller of any preceding clause, wherein the controller is: communicatively coupled to a temperature regulator, the temperature regulator controlling a temperature of the solvent within the container; and configured to send temperature instructions to the temperature regulator by which the temperature regulator to achieve a target temperature for the solvent within the container.

The controller of any preceding clause, wherein the controller is communicatively coupled to a user interface, the user interface permitting a user to select one or more characteristics of a solution that is produced by the extraction of the dissolvable material of the solute into the solvent, the controller configured to establish and update the pressure cycling instructions and the temperature instructions based on the one or more selected characteristics provided by the user interface.

A method for extracting dissolvable material from a solute, the method comprising: inserting a solute and a solvent into a container; operating a user interface to select one or more characteristics of a solution that is produced by extraction of a dissolvable material of the solute into the solvent; transmitting a signal containing the selected one or more characteristics from the user interface to a controller; determining, via the controller, pressure cycling instructions for achieving the one or more selected characteristics, the pressure cycling instructions including at least one of a target number of pressure cycles, a pressurization time corresponding to a duration of a pressurization period during which pressure in the container increases to a target pressure level, a target pressure level dwell time for which pressure in the container is maintained at the target pressure level, a depressurization time corresponding to a duration of a depressurization period during which the pressure in the container decreases from the target pressure level to a resting pressure level less than the target pressure level, and a resting pressure level dwell time for which the pressure in the container is maintained at the resting pressure level; and transmitting the pressure cycling instructions to a pressure regulator to enact at least one pressure cycle within the container, the pressure cycle at least partially assisting in the extraction of the dissolvable material of the solute into the solvent to produce the solution having the one or more selected characteristics, each pressure cycle including the pressurization period to the target pressure level and the depressurization period from the target pressure level to the resting pressure level.

The method of any preceding clause, wherein the insertion of the solute and the solvent into the container comprises: inserting the solvent into the container; inserting the solute into a vessel, the vessel having at least one opening covered by a filter, the filter permitting the solvent to enter the vessel through the filter where the solvent mixes with and at least partially extracts the dissolvable material from the solute into the solvent, the filter permitting the dissolvable material of the solute to be filtered through the filter as the dissolvable material flows out from the vessel; and with the solute in the vessel, inserting the vessel into the solvent within the container.

The method of any preceding clause, further comprising: determining, via the controller, temperature instructions for achieving the selected characteristics, the temperature instructions including a target temperature for the solvent within the container; and transmitting the temperature instructions to a temperature regulator to achieve and maintain the target temperature for the solvent within the container, the solvent being at the target temperature at least partially assisting in the extraction of the dissolvable material of the solute into the solvent.

The method of any preceding clause, wherein: the solute comprises coffee grounds and the solvent comprises water; and the extraction of the dissolvable material of the coffee grounds into the solvent produces cold brew coffee.

From the above, it is to be appreciated that defined herein is an extraction system including a container, one or more extraction components, and a controller communicatively coupled to the one or more extraction components. The one or more extraction components may be operable to control certain parameters such as, e.g., a pressure within the container and/or a temperature of a solvent in the container. Controlling these parameters increases an extraction efficiency of a solute provided within the container.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system for extracting dissolvable material from a solute, comprising:
a container removably holding a solute and a solvent for extracting dissolvable material from the solute into the solvent;
a pressure regulator controlling a pressure within the container; and
a controller communicatively coupled to the pressure regulator and configured to:
send pressure cycling instructions to the pressure regulator to enact at least one pressure cycle within the container, each pressure cycle including a pressurization period to a target pressure level and a depressurization period from the target pressure level to a resting pressure level less than the target pressure level, the pressure cycling instructions including at least one of a target number of pressure cycles, a pressurization time corresponding to a duration of the pressurization period, a target pressure level dwell time for which the pressure in the container is maintained at the target pressure level, a depressurization time corresponding to a duration of the depressurization period, and a resting pressure level dwell time for which the pressure in the container is maintained at the resting pressure level.

2. The system of claim 1, wherein the pressure cycling instructions include the target number of pressure cycles, the pressurization time, the target pressure level dwell time, the depressurization time, and the resting pressure level dwell time.

3. The system of claim 1, further comprising a pressure sensor for measuring a level of the pressure within the container, the pressure sensor being communicatively coupled to the controller, the controller configured to establish and update the pressure cycling instructions based on pressure level measurements provided by the pressure sensor.

4. The system of claim 1, wherein the pressure regulator comprises a pump operatively connected to the container, the pump selectively increasing the pressure within the container.

5. The system of claim 4, wherein the pump comprises a fluidic pump, a hydraulic pump, or a mechanical pump.

6. The system of claim 1, wherein the pressure regulator comprises a pressure relief valve operatively connected to the container, the pressure regulator selectively reducing the pressure within the container.

7. The system of claim 1, further comprising a user interface permitting a user to select one or more characteristics of a solution that is produced by the extraction of the dissolvable material of the solute into the solvent, the user interface communicatively coupled to the controller, the controller configured to establish and update the pressure cycling instructions based on the one or more selected characteristics provided by the user interface.

8. The system of claim 1, further comprising a temperature regulator communicatively coupled to the controller, the temperature regulator controlling a temperature of the solvent within the container, the controller configured to send temperature instructions to the temperature regulator to achieve a target temperature for the solvent within the container.

9. The system of claim 8, further comprising a temperature sensor for measuring the temperature of the solvent within the container, the temperature sensor communicatively coupled to the controller, the controller configured to establish and update the temperature instructions based on temperature measurements provided by the temperature sensor.

10. The system of claim 8, wherein the temperature regulator is provided on or in the container to regulate the temperature of the solvent contained within the container.

11. The system of claim 8, further comprising a user interface permitting a user to select one or more characteristics of a solution that is produced by the extraction of the dissolvable material of the solute into the solvent, the user interface communicatively coupled to the controller, the controller configured to establish and update the pressure cycling instructions and the temperature instructions based on the one or more selected characteristics provided by the user interface.

12. The system of claim 1, wherein:
the solute comprises coffee grounds and the solvent comprises water; and
the extraction of the dissolvable material of the coffee grounds into the solvent produces cold brew coffee.

13. A controller for extracting dissolvable material from a solute removably held within a container, the container removably holding a solute and a solvent for extracting dissolvable material from the solute into the solvent, the controller configured to:
send pressure cycling instructions to a pressure regulator to enact at least one pressure cycle within the container, each pressure cycle including a pressurization period to a target pressure level and a depressurization period from the target pressure level to a resting pressure level less than the target pressure level, the pressure cycling instructions including at least one of a target number of pressure cycles, a pressurization time corresponding to a duration of the pressurization period, a target pressure level dwell time for which the pressure in the container is maintained at the target pressure level, a depressurization time corresponding to a duration of the depressurization period, and a resting pressure level dwell time for which the pressure in the container is maintained at the resting pressure level.

14. The controller of claim 13, wherein the controller is communicatively coupled to a user interface, the user interface permitting a user to select one or more characteristics of a solution that is produced by the extraction of the dissolvable material of the solute into the solvent, the controller configured to establish and update the pressure cycling instructions based on the one or more selected characteristics provided by the user interface.

15. The controller of claim 13, wherein the controller is:
communicatively coupled to a temperature regulator, the temperature regulator controlling a temperature of the solvent within the container; and
configured to send temperature instructions to the temperature regulator by which the temperature regulator to achieve a target temperature for the solvent within the container.

16. The controller of claim 15, wherein the controller is communicatively coupled to a user interface, the user interface permitting a user to select one or more characteristics of a solution that is produced by the extraction of the dissolvable material of the solute into the solvent, the controller configured to establish and update the pressure cycling instructions and the temperature instructions based on the one or more selected characteristics provided by the user interface.

17. A method for extracting dissolvable material from a solute, the method comprising:
inserting a solute and a solvent into a container;
operating a user interface to select one or more characteristics of a solution that is produced by extraction of a dissolvable material of the solute into the solvent;
transmitting a signal containing the selected one or more characteristics from the user interface to a controller;
determining, via the controller, pressure cycling instructions for achieving the one or more selected characteristics, the pressure cycling instructions including at least one of a target number of pressure cycles, a pressurization time corresponding to a duration of a pressurization period during which pressure in the container increases to a target pressure level, a target pressure level dwell time for which pressure in the container is maintained at the target pressure level, a depressurization time corresponding to a duration of a depressurization period during which the pressure in the container decreases from the target pressure level to a resting pressure level less than the target pressure level, and a resting pressure level dwell time for which the pressure in the container is maintained at the resting pressure level; and
transmitting the pressure cycling instructions to a pressure regulator to enact at least one pressure cycle within the container, the pressure cycle at least partially assisting in the extraction of the dissolvable material of the solute into the solvent to produce the solution having the one or more selected characteristics, each pressure cycle including the pressurization period to the target pressure level and the depressurization period from the target pressure level to the resting pressure level.

18. The method of claim 17, wherein the insertion of the solute and the solvent into the container comprises:
inserting the solvent into the container;
inserting the solute into a vessel, the vessel having at least one opening covered by a filter, the filter permitting the solvent to enter the vessel through the filter where the solvent mixes with and at least partially extracts the dissolvable material from the solute into the solvent, the filter permitting the dissolvable material of the solute to be filtered through the filter as the dissolvable material flows out from the vessel; and
with the solute in the vessel, inserting the vessel into the solvent within the container.

19. The method of claim 17, further comprising:
determining, via the controller, temperature instructions for achieving the selected characteristics, the temperature instructions including a target temperature for the solvent within the container; and
transmitting the temperature instructions to a temperature regulator to achieve and maintain the target temperature for the solvent within the container, the solvent being at the target temperature at least partially assisting in the extraction of the dissolvable material of the solute into the solvent.

20. The method of claim 17, wherein:
the solute comprises coffee grounds and the solvent comprises water; and
the extraction of the dissolvable material of the coffee grounds into the solvent produces cold brew coffee.
